(19) United States
(12) Patent Application Publication
(10) Pub. No.: US 2026/0254671 A1
(43) Pub. Date: Aug. 27, 2026

(54) SYSTEMS, DEVICES, AND METHODS FOR UTILIZING AN OPERATOR PORTAL TO AUTOMATE COMMUNICATIONS SESSIONS

(71) Applicant: Infinitus Systems, Inc., San Francisco, CA (US)

(72) Inventors: Ankit JAIN, San Francisco, CA (US); Shyamsundar RAJAGOPALAN, San Jose, CA (US); Omar Ahmed BURNEY, Santa Clara, CA (US); Julian Charles FRUMAR, Gig Harbor, WA (US); Conal SATHI, San Francisco, CA (US); Youngseo SON, Menlo Park, CA (US)

(21) Appl. No.: 19/553,092

(22) Filed: Feb. 27, 2026

Related U.S. Application Data
(60) Provisional application No. 63/764,177, filed on Feb. 27, 2025.

(51) Int. Cl. H04L 12/18

(52) U.S. Cl. CPC H04L 12/1822; H04L 12/1818

(57) ABSTRACT

Systems, devices, and methods to automate communications via an operator portal are disclosed. A system may obtain session data generated during a communications session involving a device and a programmatic agent, the session data characterizing a query associated with a first party. The system may generate output data characterizing one or more allowable actions and determine that at least one of the one or more allowable actions is consistent with one or more constraints imposed on the trained artificial intelligence process. The system may, based on a determination that the at least one of the one or more allowable actions is insufficient to respond to the query, transmit notification data characterizing the allowable action and the query to a computing system associated with a second party. The system may receive response data characterizing a response to the query from the computing system associated with the second party.

### CROSS REFERENCE TO RELATED APPLICATION

This application claims the benefit of priority under 35 U.S.C. § 119(e) to prior U.S. Application No. 63/764,177, filed February 27, 2025, the disclosure of which is incorporated by reference herein to its entirety.

### TECHNICAL FIELD

The disclosed embodiments generally relate to systems, devices, and computer-implemented methods that implement and utilize an operator portal to automate phone calls and other communications sessions.

### BACKGROUND

Many organizations and industries leverage automated telephony systems to manage customer service, billing, technical support, and other consumer-facing tasks. Such automated telephony systems utilize many techniques to automate phone calls with limited human input, including autodialing, natural language processing, and voice recognition powered by trained machine-learning or artificial intelligence processes.

### SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

In some examples, an apparatus includes a memory storing instructions and at least one processor coupled to the memory. The at least one processor is configured to execute the instructions to obtain session data generated during a communications session involving a device and a programmatic agent. The session data characterizes a query associated with a first party. The at least one processor is further configured to execute the instructions to, based on an application of a trained artificial intelligence process to a portion of the session data, generate output data characterizing one or more allowable actions and determine that at least one of the one or more allowable actions is consistent with one or more constraints imposed on the trained artificial intelligence process. The at least one processor is further configured to execute the instructions to, based on a determination that the at least one of the one or more allowable actions is insufficient to respond to the query, transmit notification data characterizing the at least one of the one or more allowable actions and the query to a computer system associated with a second party. The at least one processor is further configured to execute the instructions to receive response data characterizing a response to the query from the computer system associated with the second party.

In other examples, a computer-implemented method includes obtaining, using at least one processor, session data generated during a communications session involving a device and a programmatic agent. The session data characterizes a query associated with a first party. The computer-implemented method also includes, based on an application of a trained artificial intelligence process to a portion of the session data, generating, using the at least one processor, output data characterizing one or more allowable actions and determining, by the at least one processor, that at least one of the one or more allowable actions is consistent with one or more constraints imposed on the trained artificial intelligence process. The computer-implemented method includes, based on a determination that the at least one of the one or more allowable actions is insufficient to respond to the query, transmitting, using the at least one processor, notification data characterizing the at least one of the one or more allowable actions and the query to a computer system associated with a second party. The computer-implemented method includes receiving, using the at least one processor, response data characterizing a response to the query from the computer system associated with the second party.

Further, in some examples, an apparatus includes a memory storing instructions and at least one processor coupled to the memory. The at least one processor is configured to execute the instructions to obtain session data generated during a communications session involving a device and a programmatic agent. The session data characterizes a query associated with a first party. The at least one processor is further configured to execute the instructions to, based on an application of a trained artificial intelligence process to a portion of the session data, detect an occurrence of a triggering event associated with the communications session. The at least one processor is further configured to execute the instructions to, based on the detection of the occurrence of the triggering event, transmit notification data characterizing the triggering event to a computer system associated with a second party, and to perform operations that augment the communications session to include the computer system associated with the second party.

The above summary is not intended to represent each embodiment or every aspect of the present disclosure. Rather, the foregoing summary provides examples of certain novel aspects and features described herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram of a computer system for automating communications sessions using an operator portal, according to certain aspects of the present disclosure.

FIG. 2 is a high-level flow diagram of an example approach to safely and reliably automate communications sessions using Large Language Models (LLMs), according to certain aspects of the present disclosure.

FIG. 3 is a block diagram that illustrates a computer system in which or with which an embodiment of the present disclosure may be implemented, according to certain aspects of the present disclosure.

FIG. 4 is a flow diagram of an exemplary approach to safely and reliably automate phone calls using Large Language Models (LLMs), according to certain aspects of the present disclosure.

FIG. 5 is a flow diagram of an exemplary approach to monitor a communications session between a programmatic agent and a first party, according to certain aspects of the present disclosure.

FIG. 6 is a flow diagram illustrating a series of exemplary queries and exemplary responses between a first party and a programmatic agent during a communications session, according to certain aspects of the present disclosure.

FIG. 7 is a diagram of an exemplary graphical user interface (GUI) of an operator portal, according to certain aspects of the present disclosure.

FIG. 8 is a flow diagram of an exemplary process for monitoring a communications session between a programmatic agent and a first party, according to certain aspects of the present disclosure.

FIG. 9 is a flow diagram of an exemplary process for detecting a triggering event in a communications session between a programmatic agent and a first party, according to certain aspects of the present disclosure.

### DETAILED DESCRIPTION

The following description outlines numerous details to thoroughly understand the present disclosure. It will be apparent, however, to one skilled in the art that the present disclosure may be practiced without some of these specific details. In other instances, well-known structures and devices are shown in block diagram form to avoid obscuring the underlying principles of the present disclosure.

The terms “component,” “module,” “system,” and the like as used herein are intended to refer to a computer-related entity, either software-executing general-purpose processor, hardware, firmware, or a combination thereof. For example, a component may be but is not limited to, a process running on a processor, a processor, an object, an executable, a thread of execution, a program, and/or a computer.

A “machine-readable medium” may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

A “Large Language Model (LLM)” represents an advanced, deep learning model trained to process, understand, and generate human language. As described herein, LLMs may be built on deep neural network architectures, particularly transformer architectures characterized by multiple layers of self-attention and feedforward neural networks, and LLMs may be trained on vast amounts of text data. LLMs consistent with the disclosed embodiments utilize probabilistic processes to predict a most likely sequence of words based on contextual information. Further, as described herein, an LLM represents an artificial intelligence (AI) processed trained to perform natural language processing (NLP) tasks upon ingestion of corresponding input data (e.g., textual content, such as input prompts, etc.), and examples of these NLP tasks include, but are not limited to, text generation, translation, summarization, and question answering. In some instances, the LLMs described herein may, upon ingestion of an input prompt, model the statistical properties of language and generate coherent and contextually relevant text responsive to the input prompt.

LLMs may be trained on massive corpora using self-supervised learning, and in some instances, the LLMs may “learn” by predicting missing words in text. The training process involves one or more of 1) “pre-training” where the LLM learns general language representations from large datasets; 2) “fine-tuning” where the LLM is adapted for specific tasks (e.g., chatbots, medical NLP); 3) “optimization" that uses backpropagation and gradient descent to minimize a loss function; and 4) “scaling" where larger scale LLM, with billions of parameters, tend to perform better due to increased capacity for pattern recognition. Further, when given an input prompt, the LLM generates text by one or more of 1) encoding inputs by converting words into embeddings; 2) applying self-attention by determining relationships between words in context; 3) passing through layers by refining representations through multiple neural network layers; 4) decoding probabilities by, for example, using a softmax function to assign probabilities to possible next words, etc.

Today, many organizations manage customer service, billing, technical support, and other consumer-facing tasks using automated telephony systems. These existing automated telephony systems may, in some instances, automate phone calls with limited human input through the implementation of various processes, including, but not limited to, autodialing, natural language processing, and machine-learning-powered or artificial-intelligence-powered voice recognition. For example, these existing systems often deploy LLMs to analyze caller input, generate responses, manage call flow, and communicate with organizational systems based on telephone calls. Although these LLMs may be pretrained using large amounts of textual data characterizing telephone calls during past temporal intervals, the LLMs employed by many existing automated telephony systems may be prone to “hallucinate” when processing textual content that deviates from corresponding training datasets and may generate factually incorrect or nonsensical output data that is inconsistent with standard operating procedures (SOPs) of the corresponding organizations.

In contrast, certain of the exemplary processes described herein may leverage a LLM to extract information characterizing a communications session involving an organization and may leverage the extracted information to compute deterministically a next action to perform based on the organization’s human-defined SOPs. The communications session may include, for example, a telephone call, a Voice over IP (VoIP) call, or an audio call transmitted over the internet. Additionally, in some examples, the communications session may include a text communications session, an instant messaging communications session, an email communications session, or any additional, or alternate, communications session capable of initiation by, and that utilizes a communications interface of, the organization. By way of example, one or more of the exemplary processes described herein may leverage a LLM to extract data from communications sessions based on text, voice, or other information of the communications sessions, and may provide the extracted data to a “next action computation” logic that is deterministic and predictable (unlike current neural network based AI models) and that chooses one of multiple pre-determined “human” responses. Unlike many existing chatbots or generative AI tools, an output of the exemplary processes described herein is explainable so that errors can be easily identified and fixed, and as described herein, the selection of the next action or response from a predetermined set reduces or eliminates the hallucinations characteristic of many existing, LLM-based processes. When implemented by one or more computer systems of an organization, certain of the exemplary processes described herein may ensure that the organization’s SOPs are correctly followed and that the corresponding output includes no incorrect information, and these exemplary processes may be implemented in addition to, or as an alternate to, many existing LLM-based systems characterized by output textual content that deviates from training data and that is inconsistent with the SOPs of the corresponding organizations.

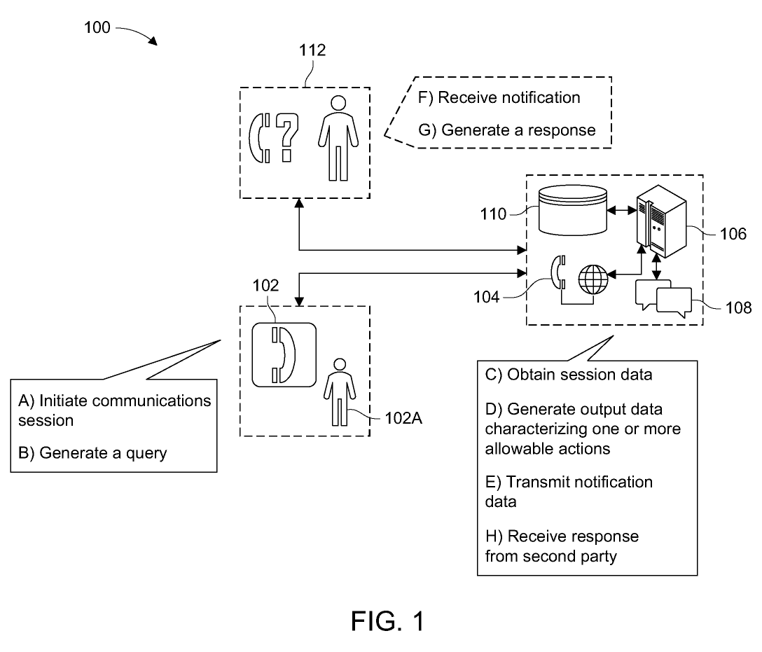

FIG. 1 is a diagram of an example environment 100 for automating communications sessions using an operator portal, according to some examples. The environment 100 may represent a deployment or operational environment of the systems, methods, and devices disclosed herein. The environment 100 includes a device 102 associated with, or operable by, a first party, such as a first party 102A. The device 102 may be a telephone, a smartphone, a tablet computer, a personal computer, a wearable device, or another device associated with the first party 102A. Further, the first party 102A may represent a user of the systems, methods, and devices disclosed herein. In some instances, the first party 102A may include a customer of an organization, e.g., a “user,” seeking to call a service hotline of the organization. For example, the first party 102A may be a patient of a medical institution associated with an insurance or healthcare provider. Additionally, or alternatively, the first party 102A may include an automated system or programmatic agent, such as, but not limited to, an automated telephone or communications system of an organization or company. Further, in some examples, the first party 102A may include a programmatic agent that is executed by one or more computing systems of the organization (e.g., and functions as a representative of the organization) and that leverages an LLM to ingest queries and produce responses.

In some examples, the first party 102A may elect to contact the organization, and the device 102 may perform operations that initiate a communications session with a provider communications interface 104 associated with the organization. The communications session may include, for example, a telephone call, a Voice over IP (VoIP) call, or an audio call transmitted over the internet. Additionally, in some examples, the communications session may include a text communications session, an instant messaging communications session, an email communications session, or any additional, or alternate, communications session capable of initiation by, and that utilizes a communications interface of, the device 102. In some instances, the device 102 and provider communications interface 104 may exchange data (e.g., voice or textual data, etc.) in real-time or in near-real-time, although in other examples, the device 102 and provider communications interface 104 may exchange the data asynchronously within the communications session.

As illustrated in FIG. 1, the provider communications interface 104 may be communicatively coupled with a computer system 106, which may be associated with, or operable by, a second party, such as the organization associated with the communications session. Examples of the computer system 106 may include, but are not limited to, a computing server or a distributed computing component within a cloud computer system, and in some instances, the computer system 106 may correspond to an automated calling system associated with the organization. The computer system 106 may, for example, execute stored software instructions and perform one or more of the exemplary processes described herein.

In some examples, the computer system 106 may be communicatively coupled with a programmatic agent 108. The programmatic agent 108 may be executed by the computer system 106, or it may be executed at a computer system communicatively coupled with the computer system 106. The programmatic agent 108 may correspond to an autonomous or automated agent that is configured to ingest input communications data and generate responses based at least in part on the ingested input communications data. For example, the programmatic agent 108 may execute a large-language model (LLM) that ingests textual or other tokenized communications session data characterizing a query or a communications session and generates one or more output tokens based at least in part on the ingested input. As such, the programmatic agent 108 may act as a chatbot or other automated communications system. The programmatic agent 108 may also use other trained machine learning or artificial intelligence techniques to ingest input data and generate output data responsive to the input data. For example, the programmatic agent 108 may receive one or more allowable actions from the computer system 106, the programmatic agent 108 may generate output data responsive to the input data based at least in part on the one or more allowable actions.

As illustrated in FIG. 1, the computer system 106 may be communicatively coupled with a database 110 that includes, among other things, information associated with the first party 102A or a product, service, or information to be provisioned to the first party 102A. For example, the database 110 may be integrated into the computer system 106 and maintained within one or more storage devices communicatively coupled with and operated by the computer system 106. In additional, or alternate, examples, the database 110 may be associated with a third party and communicatively coupled with the computer system 106 via a communications network (e.g., the Internet, etc.). Further, and as described herein, the programmatic agent 108 may perform operations that access the database 110 via the computer system 106 and ingest data from the database 110.

In some examples, the provider communications interface 104, the computer system 106, and the database 110 may be associated with the second party, e.g., a second party 112. The second party 112 may correspond to the organization associated with the initiated communications session, examples of the second party 112 may include, but are not limited to, a call center, a customer contact center, or another contact point of the organization. In some instances, the second party 112 may be associated with one or more human operators, each of which may operate, or be associated with, one or more devices communicatively coupled with the computer system 106 and/or the provider communications interface 104. In further examples, the human operators of the second party 112 may participate in communications sessions between the device 102 and the provider communications interface 104 via the computer system 106.

FIG. 1 also describes exemplary operations performed by, and involving, each of the exemplary components operating within environment 100, e.g., within stages A-H. Each of stages A-H may correspond to one or more of the exemplary operations described herein, and stages A-H do not necessarily represent discrete occurrences over time. The exemplary operations of different stages may overlap in some examples, and the exemplary operations may include greater, fewer, or different operations than those depicted in FIG. 1. Additionally, exemplary stages depicted with dashed lines in FIG. 1 may be optional or otherwise excluded from the operations depicted by stages A-H of FIG. 1.

At stage A, the device 102 of first party 102A may initiate a communications session with the provider communications interface 104. As explained above, the communications session may be a telephone call, a Voice over IP (VoIP) call, an audio call transmitted over the internet, a text communications session, an instant messaging communications session, an email communications session, or another communications session that utilizes a communications interface of the device 102. The provider communications interface 104, which is communicatively coupled with the device 102, may transmit information related to the communications session. For example, the provider communications interface 104 may be an automated phone call system, and the device 102 may communicate with the provider communications interface 104 via a telephone network, a cellular network, or the Internet. The first party 102A may initiate the communications session via the device 102, e.g., based on input provided to device 102. For example, the first party 102A may initiate the communications session via an application executed on the device 102. In other examples, the communications session may be initiated via a hyperlink contained in a web portal executed on the device 102, an email, or another function of the device 102. The communications session may generate audio, video, and/or textual data. Other data may also be transmitted within the communications session.

At stage B, the device 102 may generate a query, e.g., based on user input from the first party 102A. In some examples, such as when the first party 102A is a programmatic agent, the first party 102A may generate one or more queries and provide them to the device 102. The query may request information, data, a certain response, or one or more requested actions for the computer system 106 to perform. For example, the query may request that the computer system 106 retrieve a prior authorization for a healthcare procedure for the first party 102A. The device 102 may transmit the query to the computer system 106 via the provider communications interface 104.

At stage C, computer system 106 obtains session data that characterizes the query. For example, the computer system 106 may receive textual data characterizing the query via the provider communications interface 104, and examples of the session data include verbal, audio, or other data. In some instances the computer system 106 may generate a machine-readable representation of the query based on the session data. By way of example, the obtained session data may include an audio signal characterizing the query, and the computer system 106 may perform operations that generate the machine-readable representation of the query, e.g., a text representation of the audio signal, based on an application of one or more speech-to-text techniques to an audio signal of the query. Examples of these speech-to-text techniques may include, but are not limited to, natural language processing (NLP) techniques or trained machine learning or artificial intelligence processes.

In some examples, and in additional to generating the text representation of the audio signal, the computing system may also perform operations, described herein, that generate additional paralinguistic data characterizing the audio signal, such as, but not limited to, paralinguistic data characterizing tone, speech pace, pause, non-verbal communications markers, and other paralinguistic data associated with the audio signal, such as language and possible locale of the speaker.

The additional paralinguistic data may be encoded into the intermediate representation, e.g., the text representation of the audio signal. In other examples, the intermediate representation may include tokens, text, or other data associated with the additional paralinguistic data. Further, in some examples, the intermediate representation may include metadata that indicates speakers of the speech included in the audio signal, device information of the device 102, location information associated with the device 102 or first party 102A, or other data generated by the device 102. For example, the device 102 of the first party 102A may generate information associated with a request. The device 102 may encode the information associated with the request into the audio signal or transmit the information alongside the audio signal to the provider communications interface 104 and the computer system 106.

At stage D, the computer system 106 may determine one or more allowable actions and generate output data characterizing the one or more allowable actions. A set of allowable actions defines the actions that the computer system 106 and/or the programmatic agent 108 may take in response to an identified request of the first party 102A included in the query or the communications session. The set of allowable actions may include specific predefined responses that the programmatic agent 108 may provide, prompts that are given to the programmatic agent 108 to generate a response to the user, or a set of goals and/or tasks given to the programmatic agent 108. In some examples, the computer system 106 may determine the one or more allowable actions based on one or more guardrails or constraints. The guardrails or constraints are predetermined and represent limitations on the actions that the programmatic agent 108 may undertake. An operator of the computer system 106 may determine the guardrails or constraints, or another AI process or operations of the computer system 106 may determine the guardrails or constraints.

In some examples, determining the set of allowable actions includes applying one or more guardrails or constraints that restrict the actions available to the programmatic agent 108 at a given stage of the conversation. The computer system 106 may implement the guardrails or constraints as rules associated with states or nodes of a conversation graph, such that only those actions permitted by the guardrails at the current node may be included in the set of allowable actions.

In some examples, determining the set of allowable actions may include processing a graph that represents a conversation flow of the communications session between the first party 102A and the computer system 106. The graph may include nodes that represent questions or requested information posed by the computer system 106, and the edges may represent responses or inquiries made by the first party 102A. The computer system 106 may generate the set of allowable actions based on the determined position of the conversation with reference to the graph. In some examples, the graph may provide a representation of an intended conversation flow, and the computer system 106 may determine the current node of the graph based at least in part on the intermediate signal and the conversation history of the communications session between device 102 and the computer system 106.

At stage E, the computer system 106 may establish that the one or more allowable actions are insufficient to respond to the query. The computer system 106 may make a determination that at least one of the one or more allowable actions are insufficient to respond to the query by various techniques. The determination that at least one of the one or more allowable actions are insufficient to respond to the query may be based on an application of a trained artificial intelligence or machine learning process to the at least one of the one or more allowable actions and the session data characterizing the query. For example, the trained artificial intelligence or machine learning process may ingest a portion of the one or more allowable actions and the session data characterizing the query and determine that at least one of the one or more allowable actions does not respond sufficiently to the query of the first party. In some examples, the determination may also be based on the AI guardrails or constraints. For example, the one or more allowable actions may all conflict with the AI guardrails or constraints, meaning that the programmatic agent has no available actions to take. In this example, the computer system 106 may determine that at least one of the one or more allowable actions is insufficient to respond to the query. The computer system 106 may then transmit the notification data to the second party 112 via the provider communications interface 104.

In some examples, the computer system 106 establishes the notification data based on a determination from the computer system 106 that human assistance or other assistance from the second party 112 may be needed. The computer system 106 may transmit a request to join the communications session to a computer system or device associated with second party 112. The second party 112 may be associated with the organization that is associated with the computer system 106, or it may be operated by a third party. The second party 112 may include one or more human operators associated with devices that are communicatively coupled with the computer system 106 via the provider communications interface 104. In some examples, the programmatic agent may violate one or more of the AI guardrails, and the set of allowable actions may be limited based on the flow of conversation. The computer system 106 may determine that human or other outside intervention may be useful to assist the AI in responding to the requests or responses of the first party 102A during the communications session. The computer system 106 may determine, as an inferred next action, to request assistance from the second party 112 via the computer system or device associated with the second party 112. The computer system 106 may then transmit a request to the second party 112 via the provider communications interface 104, and a human or other outside operator of the second party 112 may join the communications session. In some examples, the second party 112 assumes control of the communications session with the first party 102A. In other examples, the second party 112 provides guidance to and/or oversight over the actions of the AI of the computer system 106.

At stage F, the computer system or device associated with second party 112 receives the notification data. A computer system associated with the second party 112 may receive the notification data. The computer system or device associated with the second party 112 may present the notification data to the second party 112 via a graphical user interface (GUI). In some examples, the GUI presented to the second party 112 also includes session data characterizing the query and/or the communications data, as well as data characterizing the conversation flow of the communications session and the one or more allowable actions of the programmatic agent 108.

At stage G, the computer system or device associated with the second party 112 may generate a response based at least in part on the notification data. For example, the second party 112 may utilize the information included in the notification data to control or guide the actions of the programmatic agent 108. The second party 112 may select at least one of the one or more allowable actions based on the information presented to the second party 112. For example, the GUI presented to the second party 112 may show the current position of the conversation of the communications session in the conversation flow based on the conversation graph. The GUI presented via the device associated with the second party may also include at least a portion of the one or more allowable actions of the programmatic agent 108. The second party 112 may select at least one of the one or more allowable actions.

The computer system or device associated with the second party 112 may also create a custom action for the programmatic agent 108 to perform. For example, if the second party 112 determines that all of the available allowable actions are insufficient to respond to a query from the first party 102A, the second party 112 may write or generate a custom action based on input provided to the computer system or device associated with the second party 112. This may include writing a custom response via the device associated with the second party 112. This may also include the second party 112 locating requested information and providing it to the programmatic agent 108. In some examples, the computer system or device of the second party 112 may execute, or access, a trained artificial intelligence or machine learning process, such as an LLM. The second party 112 may use the LLM to generate one or more new allowable actions which are then sent to the programmatic agent 108. In some examples, the second party 112 may modify the one or more allowable actions of the programmatic agent 108 or the second party 112 may modify the one or more allowable actions generated or written by the second party 112. The device associated with the second party 112 may then transmit the modified one or more allowable actions response to the computer system 106 and/or the programmatic agent 108.

At stage H, the computer system 106 receives the response from the computer system or device of the second party 112. The programmatic agent 108 may also receive the response and perform the selected action. In some examples, this represents an override of the previously selected allowable action of the programmatic agent 108. In other examples, the received response may be a selection of one or more of the allowable actions provided to the programmatic agent 108 by the computer system 106. In other examples, the second party 112 may take full or partial control of the programmatic agent 108, providing it with custom allowable actions and responses to the query from the device 102 associated with the first party 102A.

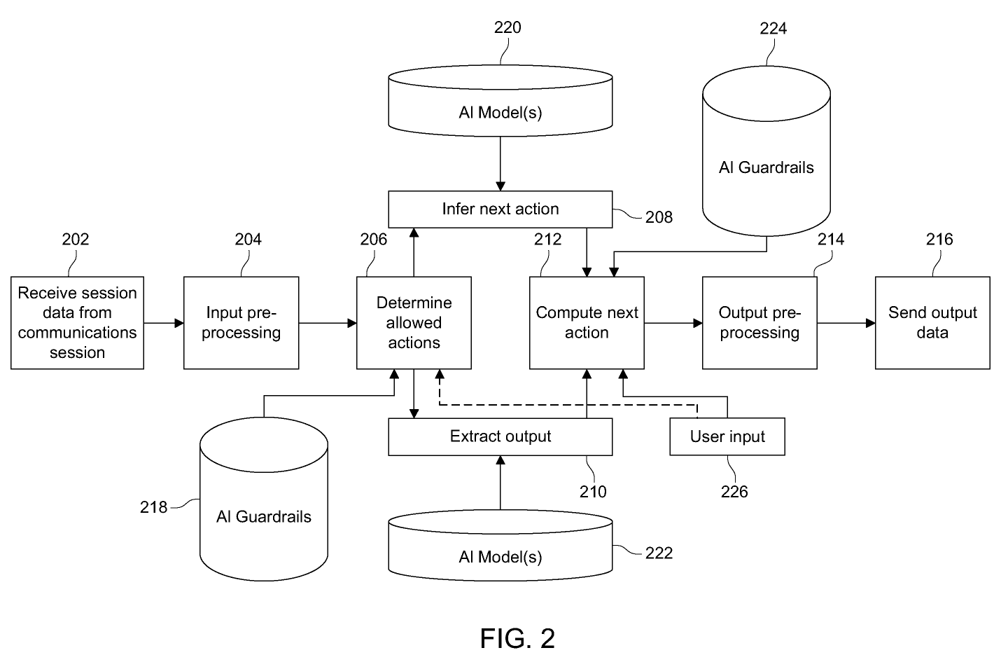

FIG. 2 is a high-level flow diagram of an example approach to safely and reliably automate communications sessions using Large Language Models (LLMs). The example of FIG. 2 is applicable to many use cases including, as just one example, the prior authorization processing as described herein.

One or more computer systems operating within environment 100, such as the computer system 106, may receive session data, such as audio and/or other input data at block 202. The session data may be, for example, from a telephone call, other audio interaction, or another type of communications session. In an example, the computer system 106 may capture audio with communication channel logic (e.g., phone call logic) that is configured to monitor (e.g., “listen”) the communications with the agent and evaluate the conversation according to various parameters (e.g., word recognition, tempo, variations). Technologies for capturing audio signals, such as telephone calls, involve a combination of hardware and software solutions to convert sound waves into electrical or digital signals, process them, and store or transmit the data. Other types of input (e.g., text, optical, etc.) may be acquired using electronic or electro-optical techniques. In further examples, the session data includes textual data such as text communications data characterizing a messaging or text communication. The computer system 106 may also engage in other types of communications sessions.

The computer system 106 may perform input pre-processing at block 204 using any of the exemplary processes described herein. In an example, the computer system 106 may convert the received audio of the session data to text. The computer system 106 may also combine other, non-audio input, with the audio input during pre-processing. The computer system 106 may utilize various speech-to-text technologies to provide this functionality. Speech-to-text technology, also known as voice-to-text or automatic speech recognition (ASR), converts spoken language into written text. It is used in applications ranging from virtual assistants to transcription services. Example speech-to-text technologies include Google Cloud Speech-to-Text (which utilizes advanced models like “Chirp,” trained on millions of hours of audio and billions of text sentences); IBM Watson Speech-to-Text (which leverages deep learning and large language models to improve accuracy and handle informal speech patterns); Microsoft Azure Speech-to-Text; etc. The computer system 106 may use other speech-to-text functionalities. For example, the computer system 106 may apply a trained neural network, deep learning model, or other machine learning or artificial intelligence process to at least a portion of the session data to generate text or other data characterizing the session data. In some examples, the artificial intelligence process applied to the session data is an LLM or a multimodal model.

In an example, the computer system 106 may perform operations, described herein, to retrieve allowable actions at block 206, e.g., in response to receiving the output of input pre-processing at block 204. In an example, the computer system 106 may utilize AI guardrails at block 218 to limit the available actions and provide additional accuracy when determining the allowable actions at block 206. As described herein, computer system 106 may utilize various AI techniques to determine one or more guardrails to be applied when determining the allowable actions.

The computer system 106 may perform limiting actions at this stage that provide AI guardrails to reduce or eliminate errors from the AI output(s). In various examples, the computer system 106 determines allowable actions by applying a trained machine learning or artificial intelligence process to the output of input pre-processing. The computer system 106 may use contextual information related to the conversation to curate a list of allowable actions (e.g., responses, inputs, decisions) to provide a more accurate next action (e.g., infer next action at block 208 and/or extract output at block 210).

In an example, the computer system 106 may compute the next action at block 212 based on inferred next action inferred at block 208, which is constrained by the allowable actions determined at block 206. Similarly, the computer system 106 may compute the next action at block 212 based on extracted output extracted at block 210, which is constrained by the allowable actions determined at block 206. One or more AI models 222 may extract the output at block 210. The computer system 106 may also compute the next action at block 212 based on user input received by the computer system 106 at block 226. The computer system 106 may receive the user input at block 226 from the device 102 associated with the first party 102A and/or the computer system associated with the second party 112. In an example, the computer system 106 uses one or more AI models such as the AI models 220 when inferring the next action.

The computer system 106 may also perform operations, described herein, that apply one or more AI guardrails or constraints (e.g., AI guardrails 224) to the next action and that apply output pre-processing at block 214. In an example, the output pre-processing may include one or more text-to-speech operations and/or providing corresponding non-audio output (e.g., text message, braille output, etc.). The computer system 106 may use this generated output to respond to the first party via, for example, one or more devices operable by the first party, e.g., device 102 of the first party. For example, at block 216, the computer system 106 may send output data to the device 102 associated with the first party 102A.

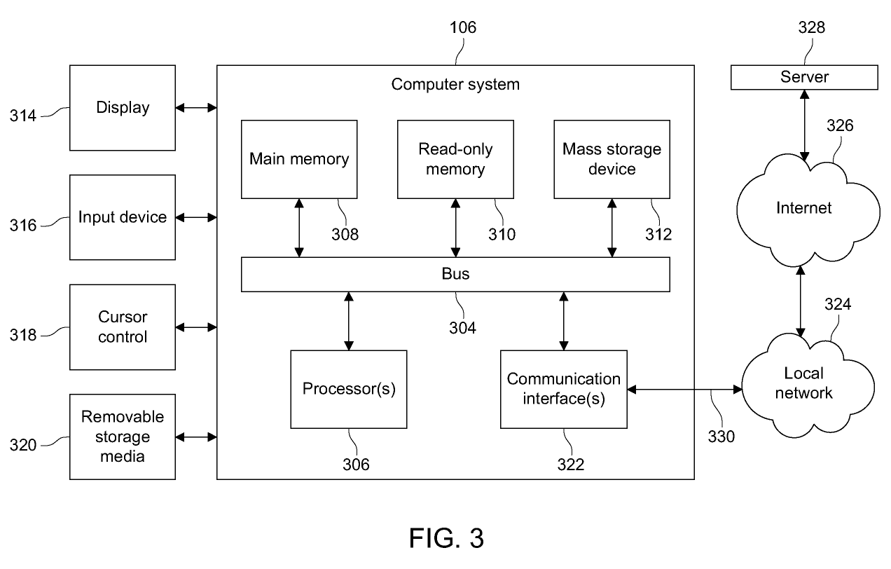

FIG. 3 is a block diagram that illustrates an exemplary computer system, such as the computer system 106 described herein, according to certain aspects of the present disclosure. Computer system 106 may be representative of an endpoint or client device on which an endpoint security agent is running and acting as a proxy on behalf of a client application (e.g., a browser). Notably, components of computer system 106 described herein are meant only to exemplify various possibilities, and in no way should exemplary computer system 106 limit the scope of the present disclosure. The computer system 106 shown in FIG. 3 may also be analogous to the device 102 of FIG. 1 or the device associated with the second party 112.

As illustrated in FIG. 3, computer system 106 may include a bus 304 or other communication mechanism for communicating information and one or more processing resources (e.g., one or more hardware processor(s) 306) coupled with bus 304 for processing information. Hardware processor(s) 306 may include, for example, one or more general-purpose microprocessors available from one or more current or future microprocessor manufacturers (e.g., Intel Corporation, Advanced Micro Devices, Inc., and/or the like) and/or one or more special-purpose processors (e.g., CPs, NPs, and/or accelerators or co-processors). In some examples, one or more processing resources may be part of an ASIC-based security processing unit (e.g., the FORTISP family of security processing units available from Fortinet, Inc. of Sunnyvale, CA).

Computer system 106 may also include main memory 308, such as a random-access memory (RAM) or other dynamic storage device, coupled to bus 304 for storing information and instructions to be executed by processor(s) 306. Main memory 308 also may be used for storing temporary variables or other intermediate information during execution of instructions to be executed by processor(s) 306. Such instructions, when stored in non-transitory storage media accessible to processor(s) 306, render computer system 106 into a special-purpose machine customized to perform the operations specified in the instructions.

Computer system 106 may include a read-only memory 310 or other static storage device coupled to bus 304 for storing static information and instructions for processor(s) 306. For example, a mass storage device 312 (e.g., a magnetic disk, optical disk or flash disk (made of flash memory chips), may be coupled to bus 304 for storing information and instructions.

Computer system 106 may also be coupled via bus 304 to display 314 (e.g., a cathode ray tube (CRT), Liquid Crystal Display (LCD), Organic Light-Emitting Diode Display (OLED), Digital Light Processing Display (DLP) or the like, for displaying information to a computer user. Further, one or more input devices, such as an input device 316 including alphanumeric and other keys, may be coupled to bus 304 for communicating information and command selections to processor(s) 306. The one or more input devices may also include a cursor control 318, such as a mouse, a trackball, a trackpad, or cursor direction keys for communicating direction information and command selections to processor(s) 306 and for controlling cursor movement on display 314. The one or more input devices may be characterized by two degrees of freedom in two axes, a first axis (e.g., x) and a second axis (e.g., y), that allows the device to specify positions in a plane.

Further, computer system 106 may also include a removable storage media 320, which may be any kind of external storage media, including, but not limited to, hard-drives, floppy drives, IOMEGA® Zip Drives, Compact Disc – Read Only Memory (CD-ROM), Compact Disc – Re-Writable (CD-RW), Digital Video Disk – Read Only Memory (DVD-ROM), USB flash drives and other external storage media.

Computer system 106 may implement the techniques described herein using customized hard-wired logic, one or more ASICs or FPGAs, firmware or program logic which in combination with the computer system causes or programs computer system 106 to be a special-purpose machine. In one example, computer system 106 may perform one or more of the exemplary processes described herein in response to processor(s) 306 executing one or more sequences of one or more instructions contained in main memory 308. Computer system 106 may, for example, read these instructions into main memory 308 from another storage medium, such as mass storage device 312. Further, an execution of the sequences of instructions contained in main memory 308 causes processor(s) 306 to perform the process steps described herein. In alternative examples, hard-wired circuitry may be used in place of or in combination with software instructions.

The term “storage media” as used herein refers to any non-transitory media that store data or instructions that cause a machine to operate in a specific fashion. Such storage media may comprise non-volatile media or volatile media. Non-volatile media includes, for example, optical, magnetic, or flash disks, such as mass storage device 312. Volatile media includes dynamic memory, such as main memory 308. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wires, and fiber optics, including the wires that comprise bus 304. Transmission media may also be acoustic or light waves, such as those generated during radio-wave and infrared data communications.

Various forms of media may be involved in carrying one or more sequences of one or more instructions to processor(s) 306 for execution. For example, a magnetic disk or solid-state drive of a remote computer may initially carry the instructions. The remote computer may load the instructions into its dynamic memory and send the instructions over a telephone line using a modem. A modem local to computer system 106 may receive the data on the telephone line and use an infrared transmitter to convert the data to an infrared signal. An infrared detector may receive the data from the infrared signal, and appropriate circuitry may place the data on bus 304. Bus 304 carries the data to main memory 308, from which processor(s) 306 retrieve and execute the instructions. The computer system 106 may optionally store the instructions received by main memory 308 on mass storage device 312 either before or after execution by processor(s) 306.

Computer system 106 may also include communication interface(s) 322 coupled to bus 304. Communication interface(s) 322 provides a two-way data communication coupling to network link 330 that is connected to local network 324. For example, communication interface(s) 322 may be an integrated services digital network (ISDN) card, cable modem, satellite modem, or a modem to provide a data communication connection to a corresponding type of telephone line. Another example is communication interface(s) 322 which may be a local area network (LAN) card that provides a data communication connection to a compatible LAN. Wireless links may also be implemented. In any such implementation, communication interface(s) 322 sends and receives electrical, electromagnetic or optical signals that carry digital data streams representing various types of information.

A network link 330 may provide data communication through one or more networks to other data devices. For example, a local network 324 and internet 326 both use electrical, electromagnetic or optical signals that carry digital data streams. The signals through the various networks and network link 330 and through communication interface(s) 322, which carry the digital data to and from computer system 106, are example forms of transmission media.

Computer system 106 may send messages and receive data, including program code, through the network(s), network link 330 and communication interface(s) 322. For example, server 328 might transmit a requested code for an application program through local network 324 and communication interface(s) 322. The received code may be executed by processor(s) 306 as it is received or stored in mass storage device 312 or other non-volatile storage for later execution.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The term "logic" may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein.

Computer executable components can be stored, for example, on non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device type, in accordance with the claimed subject matter.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

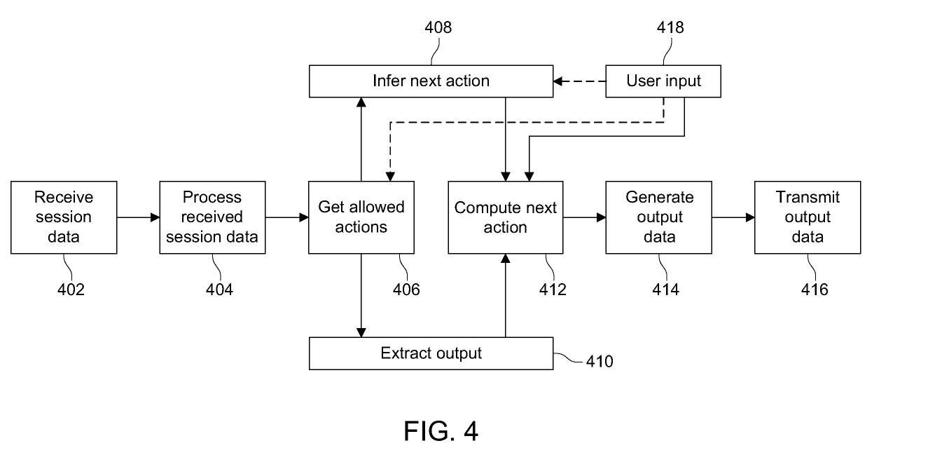

FIG. 4 is a flow diagram of an exemplary approach to safely and reliably automate phone calls using Large Language Models (LLMs). The exemplary approach described in reference to FIG. 4 may correspond to an overall operational flow for communication during a communications session with a programmatic agent over a communication channel (e.g., a telephone call, a text communications session, a video call, a voice call, an email communications session, or another communications session). The exemplary approach illustrated in FIG. 4 may also support other types of calls and or non-telephone call communication channels. For example, the exemplary techniques and operations depicted in FIG. 4 may be used to automate conversations automated using an LLM executed by the programmatic agent that are performed over text message, video call, audio message, email, or instant message. Further, in some examples, one or more computer systems operating within environment 100, such as the computer system 106, may perform operations at one or more of the blocks of the exemplary approach of FIG. 4.

At block 402, the computer system 106 may receive session data characterizing a communications session from an agent via a communications channel. In an example, the session data includes audio data from an audio call, and the computer system 106 may perform operations that capture the audio with communication channel logic (e.g., phone call logic) that is configured to monitor (e.g., “listen to”) the communications with the agent and evaluate the conversation according to various parameters (e.g., word recognition, tempo, variations). Technologies for capturing audio signals, such as telephone calls, involve a combination of hardware and software solutions to convert sound waves into electrical or digital signals, process them, and store or transmit the data. For example, the computer system 106 may receive the session data via the communications channel, and the computer system 106 may include hardware such as digital signal processors (DSPs), graphics processing units (GPUs) and one or more processors configured to receive audio data and process them into digital representations. For example, the one or more processors of the computer system 106 may be configured to convert analog telephone data to a digital representation.

At block 404, the computer system 106 may perform operations that convert the received session data to machine-readable data. For example, the session data may include audio data, and the computer system 106 may utilize various speech-to-text technologies to provide this functionality. Speech-to-text technology, also known as voice-to-text or automatic speech recognition (ASR), converts spoken language into written text and may be used in applications ranging from virtual assistants to transcription services. Example speech-to-text technologies include Google Cloud Speech-to-Text (which utilizes advanced models like “Chirp,” trained on millions of hours of audio and billions of text sentences); IBM Watson Speech-to-Text (which leverages deep learning and large language models to improve accuracy and handle informal speech patterns); Microsoft Azure Speech-to-Text; etc. In some examples, the computer system 106 may use a natural language processing (NLP) speech-to-text technology. In other examples, the computer system 106 implements speech-to-text functionality through the application of a trained machine learning or artificial intelligence process to the received session data, for example, a neural network.

At block 406, in an example, the computer system 106 may determine allowable actions, e.g., in response to receiving the output of speech-to-text generated at block 404. Further, in step 406, the computer system 106 may perform limiting actions that provide AI guardrails to reduce or eliminate errors from the AI output(s). In various examples, the computer system 106 may determine the allowable actions by applying a trained machine learning or artificial intelligence process to the received session data. The computer system 106 may also determine the allowable actions based on pre-established conversational flows received by the computer system 106. As illustrated in FIG. 4, the computer system 106 may perform operations that curate a list of allowable actions (e.g., responses, inputs, decisions) based on contextual information related to the conversation, which may enable the computer system 106 to provide a more accurate next action (e.g., infer next action at block 408 and/or extract output at block 410). In an example, the list of actions may include computed actions or a combination of computed and human-developed actions. Allowable actions may be limited to a single option or may include a list of allowable actions, depending on the context of the conversation.

At block 412, in an example, the computer system 106 may perform operations that compute the next action, e.g., based on inferred next action computed at block 408, which is constrained by the allowable actions determined at block 406. In some examples, the computer system 106 may compute the next action based on (i) the inferred next action, (ii) one or more extracted outputs extracted at block 410, or (iii) any combination of (i)–(ii), with options constrained by the allowable actions determined at block 406. In some examples, the computer system 106 may also infer the next action 408 based on user input received by the computer system 106 at block 418. The computer system 106 may base its choice of which next action to use on the context of the conversation as indicated by the session data characterizing the communications session. Some example conversation flows include: 1) Q: “What is your name?.” The programmatic agent may respond: “Manas Paldhe,” in which case the computer system 106 may extract output from the response and use it to compute the next action. Another example is 2) Q: “What is your name?” wherein the agent may respond: “Sorry could you repeat that please?,” in which case the computer system 106 uses the inferred next action rather than extracted output. The computer system 106 may generate output data based at least in part on the computed next action at block 414. The computer system 106 may use, for example, the application of a trained machine learning or artificial intelligence process to implement text-to-speech functionality. For example, the computer system 106 may apply a neural network to the text to generate speech. Other NLP techniques may also be used to generate speech from the text. At block 416, the computer system 106 may transmit the output data to a device associated with the first party or to the computer system associated with the second party 112. For example, the computer system 106 may transmit the generated speech to devices associated with the first party, e.g. the device 102.

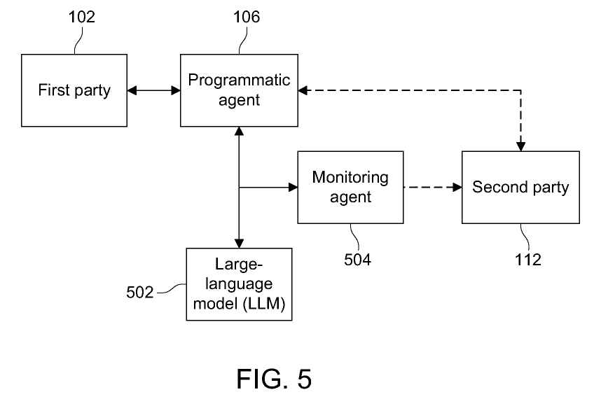

FIG. 5 is a flow diagram of an exemplary approach to monitor a communications session between the first party 102A via the device 102 and the programmatic agent 108. A communications session monitored by the approach may use the guardrails or constraints shown in FIGS. 2-4.

As illustrated in FIG. 5, the programmatic agent 108 may utilize a large language model (LLM) 502 to engage in a communications session with the device 102 associated with the first party 102A. In some examples, the programmatic agent 108 may execute the LLM 502. The first party 102A may be a human, or alternatively, another programmatic agent that executes another associated LLM. The conversation flow of the communications session may take various forms. The conversational flow may be related to, for example, medical-related issues, logistics-related issues, information gathering operations, or other conversation flows that require an exchange of data and information between the participants using a communications protocol. In some examples, the conversation flow or an intended conversation flow of the communications session may be characterized by a graph comprising nodes and edges. The conversation graph may include nodes that represent questions or requested information posed by the programmatic agent 108, and the edges may represent responses or inquiries made by the first party 102A via the device 102. In some examples, the conversation graph provides a representation of an intended conversation flow of the communications session, and the current node of the graph is determined based at least on session data characterizing the communications session and the conversation history of the communications session between the first party 102A and the programmatic agent 108.

As shown in FIG. 5, the first party 102A and the programmatic agent 108 may engage in a communications session via the device 102. The programmatic agent 108 may use the provider communications interface 104, which may be communicatively coupled with the computer system 106, to engage in the communications session with the device 102. At least one processor of the computer system 106 executes the programmatic agent 108, and in some examples, the programmatic agent 108 executes one or more LLMs such as the LLM 502. The programmatic agent 108 may execute the one or more LLMs such as the LLM 502 using the at least one processor of the computer system 106. The LLM 502 analyzes session data characterizing the communications session between the device 102 and programmatic agent 108. For example, the LLM 502 may ingest textual or other session data of the communications session. Based on the ingested data, the LLM 502 may generate one or more output tokens associated with the communications session. The output tokens may be intended to form a reply message or communication to be transmitted by the programmatic agent 108 to the device 102, and the reply message or communication may be a reply to a message or communication sent by the first party 102A. In some examples and conversation flows, the LLM 502 may generate one or more queries to be sent to the device 102 via the programmatic agent 108 and the provider communications interface 104. The queries may be intended for the first party 102A, and the queries may be based on information associated with the first party 102A.

In some examples, the computer system 106 and/or the programmatic agent 108 may analyze the one or more allowable actions based on the session data characterizing the communications session. The computer system 106 and/or the programmatic agent 108 may apply one or more guardrails or constraints when determining the one or more allowable actions, as explained in reference to FIGS. 2-4. The guardrails or constraints may explicitly indicate to the programmatic agent 108 and/or the LLM 502 a set of next actions that are available (or are appropriate). The guardrails or constraints may also indicate a set of parameters, one or more of which must be satisfied by a selected next action of the programmatic agent 108 and/or the LLM 502.

The programmatic agent 108, the device 102, and the LLM 502 may be communicatively coupled to a monitoring agent 504. The monitoring agent 504 may monitor the communications session between the programmatic agent 108 and the device 102. The monitoring agent 504 is configured to monitor the communications session and provide oversight for the conversation between the first party 102A and the programmatic agent 108. In some examples, to facilitate the monitoring and the provisioning of oversight, the monitoring agent 504 may receive session data that characterizes the communications session between the programmatic agent 108 and the first party 102A. The session data may include textual data indicative of the content of the communications session, voice or speech data of the communications session, metadata related to the communications session, the device 102, the programmatic agent 108, and/or the first party 102A, and other data characterizing the conversation of the communications session. Based on the session data, the monitoring agent 504 may transmit data characterizing the communications session to a computer system or device associated with the second party 112. The monitoring agent 504 may present the data characterizing the communications session to the second party 112 via a GUI presented via a display device of the computer system or device associated with the second party 112. For example, the second party 112 may be a human operator, and the human operator may view the data characterizing the communications session between the device 102 and the programmatic agent 108 via a graphical user interface on a computer system or device associated with the second party 112. In some examples, the computer system or device associated with the second party 112 presents the second party 112 with a visual representation of the conversation flow of the communications session between the device 102 and the programmatic agent 108. The computer system or device associated with the second party 112 may base the visual representation at least in part on the conversation graph associated with the communications session. The visual representation may include visual or graphical representations of messages and information sent by the device 102 and/or the programmatic agent 108. In some examples, the visual representation presented to the second party 112 via the computer system or device includes one or more visual indicia of the one or more allowable actions of the programmatic agent 108 and/or the LLM 502. In further examples, the visual indicia of the one or more allowable actions may include visual indications that certain allowable actions have been taken, certain allowable actions have not been taken, and certain allowable actions have been determined to be improper based on the position in the conversation flow of the communications session, as indicated by the conversation graph.

The monitoring agent 504 may utilize various techniques to monitor the conversation between the device 102 and the programmatic agent 108. In some examples, the monitoring agent 504 may search for predefined keywords in the session data characterizing the communications session. For example, the monitoring agent 504 may search for predefined keywords that include, but are not limited to, “chest,” “pain,” “breath,” “heart,” and other cardiopulmonary-related terms, and based on a presence of one or more of these keywords in the session data characterizing the communications session, the monitoring agent 504 may determine that the first party 102A is experiencing a cardiac event during the communications session. In some examples, the monitoring agent 504 may also determine that the first party 102A is experiencing a cardiac event, or another type of event, based on a risk score determined by the monitoring agent. The monitoring agent 504 may monitor the communications session by applying a trained artificial intelligence or machine learning process to at least the session data characterizing the communications session. For example, the monitoring agent 504 may present a summary of the communications session to the second party 112 via the computer system or device associated with the second party 112 based on the application of a trained artificial intelligence or machine learning process to the session data characterizing the communications session. In some examples, the trained machine learning or artificial intelligence process may include an LLM associated with the monitoring agent 504.

The second party 112 may utilize the information presented by the monitoring agent 504 to control or guide the actions of the programmatic agent 108 and/or the LLM 502, e.g., based on input provisioned to the computer system or device associated with the second party 112. The second party 112 may, in some instances, provide input that selects at least one of the one or more allowable actions based on the information presented to the second party 112. For example, the GUI presented to the second party 112 via the device associated with the second party 112 may show the current position of the conversation of the communications session in the conversation flow based on the conversation graph. The GUI may also present at least a portion of the one or more allowable actions of the programmatic agent 108 and/or the LLM 502. The second party 112 may provide input to the device that selects at least one of the one or more allowable actions, and the computer system or device associated with the second party 112 then may transmit the selection to the programmatic agent 108, which performs the selected action. In some examples, the performance of the selected action may represent an override of the previously selected allowable action of the programmatic agent 108.

The second party 112 may also provide input to the device that creates a custom action capable of performance by the programmatic agent 108. For example, if the second party 112 determines that all of the available allowable actions are insufficient to respond to a query from the first party 102A, the second party 112 may write or generate a custom action, e.g., a custom response, via the computer system or device associated with the second party 112. In some instances, in writing or generating the custom action, the second party 112 may locate requested information and provide the located information to the programmatic agent 108 using any of the processes described herein. In some examples, the computer system or device associated with the second party 112, or another computer system or device accessible to or operable by the second party 112, may execute a trained artificial intelligence or machine learning process, such as an LLM. And the second party 112 may use the LLM to generate one or more new allowable actions, which may be provided to the programmatic agent 108 using any of the processes described herein. In some examples, the second party 112 may modify the one or more allowable actions of the programmatic agent 108 or the second party 112 may modify the one or more allowable actions generated or written by the second party 112. The computer system or device associated with the second party 112 may transmit the modified one or more allowable actions to the programmatic agent 108.

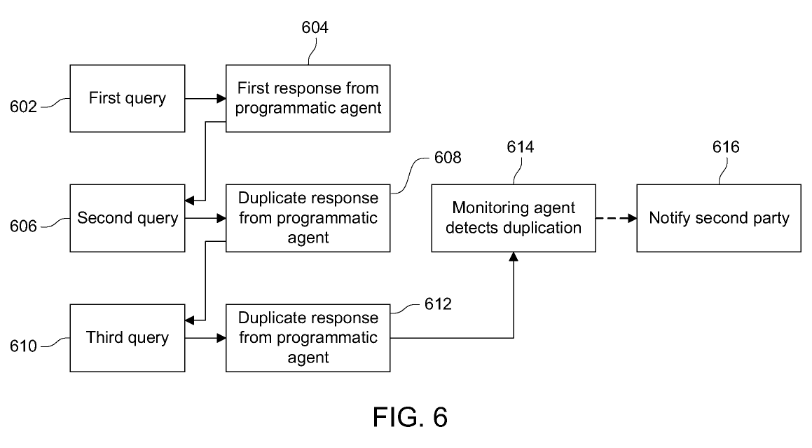

FIG. 6 is a flow diagram illustrating a series of exemplary queries and exemplary responses between the first party 102A and the programmatic agent 108 during a communications session. Similar to the exemplary approach illustrated in FIG. 5, the first party 102A and the programmatic agent 108 may be engaged in a communications session via the device 102 and the provider communications interface 104.

As illustrated in FIG. 6, the first party 102A may use the device 102 to transmit a first query 602 to the computer system 106, which may execute the programmatic agent 108, and the programmatic agent 108 may analyze the first query 602. In some examples, the programmatic agent 108 may use an LLM, such as the LLM 502 shown in FIG. 5, to analyze the first query 602. The programmatic agent 108 may also access or obtain a set of one or more allowable actions, e.g., as determined by the computer system 106 or another process. In some examples, the computer system 106 may analyze the one or more allowable actions based on session data characterizing the communications session and may perform operations, described herein and in reference to FIGS. 2-4, that apply one or more guardrails or constraints when determining the one or more allowable actions. The guardrails or constraints may explicitly indicate to the programmatic agent 108 and/or the LLM 502 a set of next actions that are available (or are appropriate). The guardrails or constraints may also indicate a set of parameters, one or more of which must be satisfied by a selected next action of the programmatic agent 108 and/or the LLM 502.

Based on its analysis, and on the one or more allowable actions and/or guardrails and constraints, the programmatic agent 108 may generate and transmit a first response 604 to the device 102. The first response may be based on the content or data included in the first query 602, and the first response 604 may respond to at least a portion of the first query 602. In an example conversation, the first query 602 may be “what are the benefits included in patient A’s insurance plan?” The first response 604 may include a response to at least a portion of this query. For example, the first response 604 may include the response “Patient A’s insurance plan includes dental coverage.”

The first response 604 may be sufficient to respond to the first query 602, or alternatively, the first response 604 may be insufficient. In either instance, the first party 102A may use the device 102 to generate a second query 606 and to transmit the second query 606 to the computer system 106 for analysis by the programmatic agent 108. The programmatic agent 108 may perform any of the exemplary processes described herein to determine and transmit a first duplicate response 608 to device 102. The duplicate response 608 may be identical or similar to the first response 604. For example, the content of the duplicate response 608 may be similar to that of the first response 604, or the data included in the duplicate response 608 may be similar to that included in the first response 604. In some examples, such as when the first response 604 is insufficient to respond to at least a portion of the first query 602, the first duplicate response 608 may also be insufficient to respond to at least a portion of the first query 602 or the second query 608. The insufficiency of the first duplicate response 608 may indicate a circular or repetitive response pattern of the programmatic agent 108 and additionally, or alternatively, may indicate that the programmatic agent 108 is incapable of answering at least a portion of the first query 602 and/or the second query 606. In some examples, a monitoring agent (e.g., monitoring agent 504, etc.) may flag, mark, or otherwise note that the conversation flow of the communications session has entered a circular pattern, e.g., after any number of repetitive or insufficient responses. As shown in FIG. 6, device 102 may generate a third query 610 (e.g., based on input provided by the first party 102A) and may transmit the third query 610 to the computer system 106. The programmatic agent 108 may then generate and transmit a second duplicate response 612, and at this point in the conversation flow, the monitoring agent may detect a duplication of responses or a circular conversation flow at block 614. As shown in FIG. 5, the monitoring agent may have been monitoring the communications session, and based on the detection of duplication at block 614, the monitoring agent may notify a second party, such as second party 112, at block 616, via the computer system or device associated with the second party 112. For example, the monitoring agent may cause a presentation of a graphical user interface element indicating a repetitive or circular conversation flow in the communications session via the computer system or device associated with the second party 112.

In some examples, the second party 112 may review the circular or repetitive conversation using the computer system or device, and based on input provisioned by the second party 112, the computer system or device may generate a sufficient response to the queries posed by the first party 102A. For example, the second party 112 may select or modify one or more of the one or more allowable actions of the programmatic agent 108, or the second party 112 may determine a custom response to the queries of the first party. The computer system or device of the second party 112 then transmits the determined actions to the programmatic agent 108, intervening in the communications session to end or remedy the circular or repetitive conversation

In some examples, the monitoring agent may detect one or more other triggering events in the session data characterizing the communications session. For example, the monitoring agent may determine that a circular or repetitive conversation, as shown in FIG. 6, may be a triggering event. Based on the triggering event, the monitoring agent may notify the second party 112 via the computer system or device associated with the second party 112 that a triggering event has been detected in the session data characterizing the communications session. The second party 112 may then control or otherwise assist the programmatic agent 108 based at least in part on the triggering event using the computer system or device.

Examples of triggering events include, but are not limited to: a misunderstood query, an inability of the programmatic agent 108 to generate a sufficient response to the query, a medical emergency, a presence of repetitive conversation flow within the communications session, or a presence of a flagged topic within the communications session. Other triggering events may be established, in some examples, based on an application of a trained machine learning or artificial intelligence process to the session data characterizing the communications session. For example, based on an application of a trained machine learning or artificial intelligence process to the session data characterizing the communications session, the computer system 106 may determine one or more events that may be designated as a triggering event for detection in future communications sessions.

The monitoring agent may detect triggering events based on an application of a trained machine learning or artificial intelligence process to the session data characterizing the communications session. For example, the monitoring agent may use an LLM to analyze the session data characterizing the communications session. Based on the output of the LLM, the monitoring agent may detect a presence of a triggering event. In other examples, the monitoring agent may apply a trained machine learning or artificial intelligence process to the session data characterizing the communications session, and based on the output of the trained machine learning or artificial intelligence process, the monitoring agent may determine a risk score or triggering event score. Based on the risk score or triggering event score, the monitoring agent may detect a presence of a triggering event.

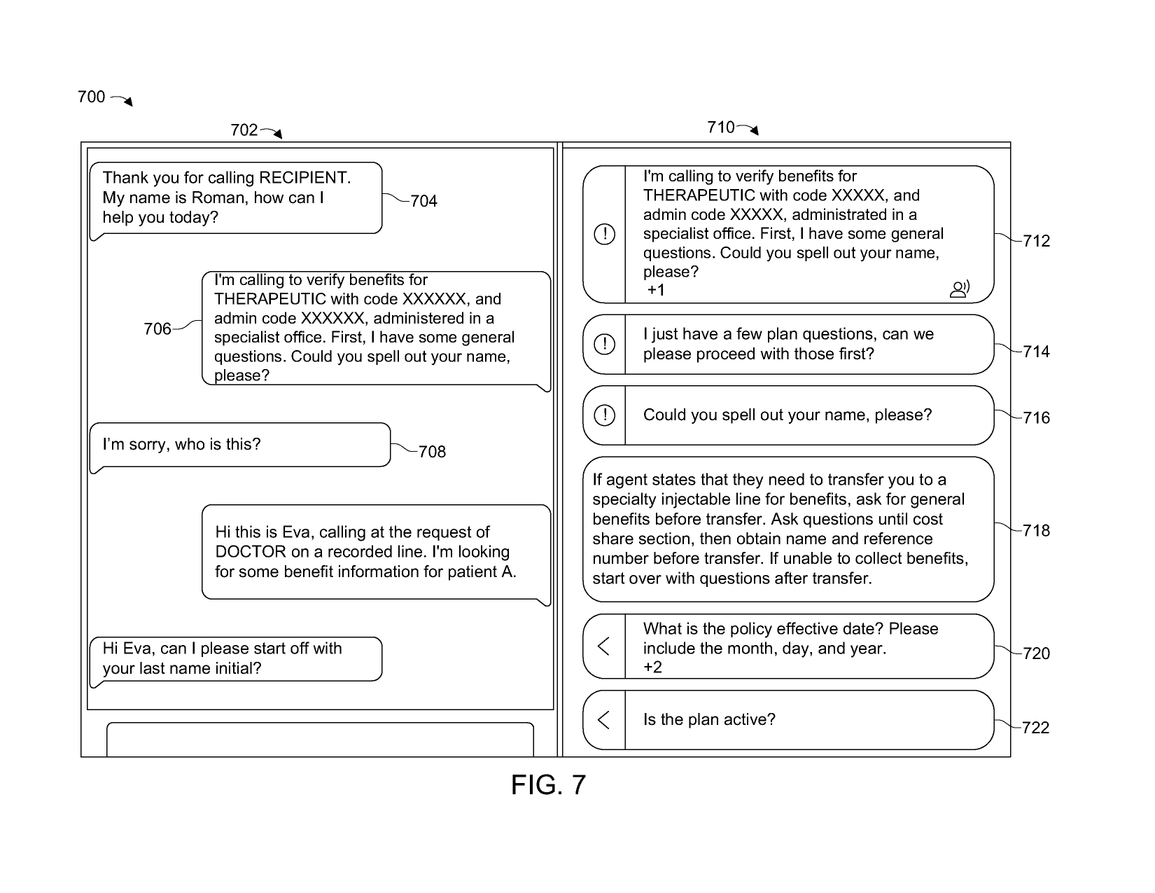

FIG. 7 is a diagram of an exemplary graphical user interface (GUI) 700 of an operator portal. In some examples, a computer system or device of second party 112 may present GUI 700 to second party 112, and second party 112 may interact with GUI 700 and provide operator oversight to the exemplary processes described herein that safely and reliably automate phone calls using Large Language Models (LLMs).

Referring to FIG. 7, a panel 702 of GUI 700 that illustrates a conversation flow of a communications session between a device associated with a first party, such as first party 102A, and a programmatic agent, such as programmatic agent 108, is shown in the leftmost panel 702. In the example conversation the first party may initiate the conversation, asking the programmatic agent how it may be helped today at block 704. In this example, the first party is an automated telephone system at a healthcare insurance provider, and the programmatic agent is executed by one or more computing systems associated with an individual or a healthcare provider of the individual (e.g., and functions as a representative of the individual and/or the healthcare provider) and that leverages an LLM to ingest queries and produce responses. The programmatic agent’s response is shown at block 706, where it asks about specific benefit information. At block 708, the automated telephone system’s response is shown, indicating that it did not understand the query or that it could not sufficiently respond to the programmatic agent. In some examples, as shown at block 708, the automated telephone system may respond “I’m sorry, who is this?” This may indicate that, for example, the automated system of the first party or the programmatic agent is having trouble responding to the recipient within the allocated guardrails.

In panel 710, the second party may be presented with GUI elements that show the one or more allowable actions of the programmatic agent, and other session data characterizing the query and the communications session. As shown in blocks 712, block 714, and block 716, the GUI 700 may present the second party via the device associated with the second party with the selected allowable actions that the programmatic agent took in the conversation displayed in the panel 702. As shown, the visual element displaying each of the allowable actions taken may include a visual indication that the allowable action or query was not sufficiently answered by the automated telephone system. As such, the query may have been misunderstood or the programmatic agent failed to receive requested information from the automated telephone system. The GUI 700 may also present the second party with an analysis at block 718 that shows a prompt for the LLM executed by the programmatic agent. This provides the second party with an insight into the operations of the programmatic agent and what the future actions of the programmatic agent may be. In some examples, the second party may utilize the GUI 700 presented by the device associated with the second party to modify the prompt of the programmatic agent or write a custom prompt for the programmatic agent.

The GUI 700 may also present the available allowable actions for the programmatic agent. These available allowable actions may have been generated based on the session data characterizing the query or the communications session. The available allowable next actions may also have been generated based on an application of the LLM executed by the programmatic agent to the session data characterizing the communications session. As shown in blocks 718 and 720, the available allowable next actions may be presented to the second party via the GUI, and the blocks 720 and 722 may include visual indicia that indicate that the displayed next actions are available. The second party may use the GUI 700 to select one of the available allowable actions.

As another example, the second party may also use the GUI 700 to select, organize and/or prioritize available allowable actions. In some examples, the second party may modify the available allowable actions and/or determine new allowable actions for the programmatic agent.

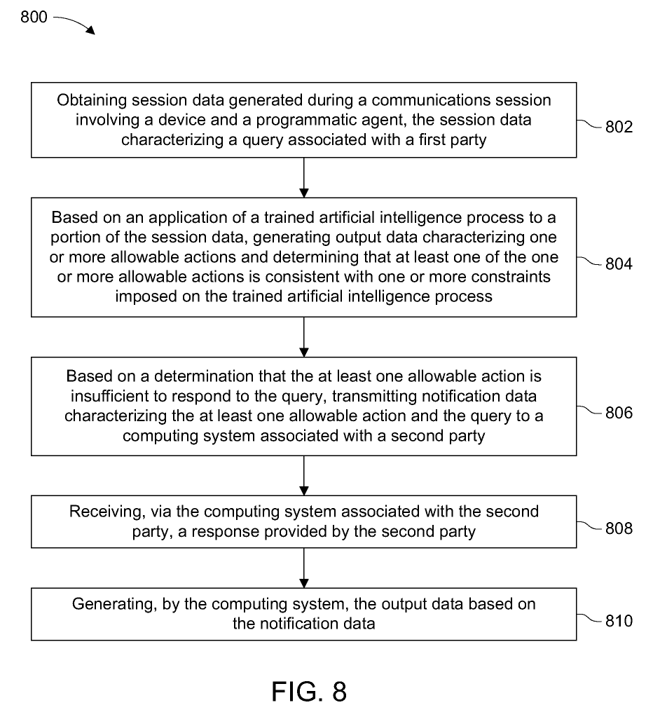

FIG. 8 is a flow diagram of an exemplary process 800 for monitoring a communications session between the programmatic agent 108 and the first party 102A. In some instances, one or more computer systems operating within environment 100, such as the computer system 106, the device 102, or the device associated with the second party 112, may perform one or more of the blocks of exemplary computer-implemented method 800, which begins at block 802.

At block 802, the computer system 106 may obtain session data generated during a communications session involving a device and a programmatic agent, the session data characterizing a query associated with a first party. The first device may be the device 102 associated with the first party 102A. The programmatic agent may be the programmatic agent 108, and may execute an LLM. The query may request information, assistance, or another action to be performed by the programmatic agent. The communications session may be a textual communications session, a verbal communications session, or another type of communications session implemented via a communications protocol. The session data characterizing the query associated with the first party may include information indicative of the query, metadata related to the communications session, or other information.

At block 804, the computer system 106 may, based on an application of a trained artificial intelligence process to a portion of the session data, generate output data characterizing one or more allowable actions and determine that at least one of the one or more allowable actions is consistent with one or more constraints imposed on the trained artificial intelligence process. The trained artificial intelligence process may be a machine learning process, and in some examples, the trained artificial intelligence process is an LLM. In an example, the computer system 106 may utilize AI guardrails or constraints at block 804 to limit or modify the allowable actions and provide additional accuracy when determining the allowable actions at block 806. As described herein, computer system 106 may utilize various AI techniques to determine one or more guardrails to be applied when determining the allowable actions. The output data characterizes one or more allowable actions to be performed by the programmatic agent. The computer system 106 may also generate the one or more allowable actions based on a conversation graph indicating an intended conversation flow of the communications session between the device and programmatic agent.

At block 806, the computer system 106 may, based on a determination that the at least one of the one or more allowable actions is insufficient to respond to the query, transmit notification data characterizing the at least one of the one or more allowable actions and the query to a computer system associated with a second party. The determination that the at least one of the one or more allowable actions is insufficient to respond to the query may be based on an application of a trained artificial intelligence or machine learning process to the one or more allowable actions and the session data characterizing the query. For example, the trained artificial intelligence or machine learning process may ingest a portion of the one or more allowable actions and the session data characterizing the query and determine that the at least one of the one or more allowable actions does not respond sufficiently to the query of the first party. In some examples, the computer system 106 may determine that the at least one of the one or more allowable actions does not respond sufficiently to the query of the first party based on the AI guardrails or constraints. For example, the one or more allowable actions may all conflict with the AI guardrails or constraints, meaning that the programmatic agent has no available actions to take. In this instance, the computer system 106 will determine that the at least one of the one or more allowable actions is insufficient to respond to the query.

Based on the determination, the computer system 106 transmits notification data to the computer system of the second party, the notification data indicating that the at least one of the one or more allowable actions is insufficient to respond to the query. The computer system of the second party also receives the query and/or the session data characterizing the query. The second party may be the second party 112. The second party may use the corresponding computer system to review the notification data, the query, and the communications session. For example, the computer system associated with the second party may present a GUI to the second party that illustrates the conversation flow of the communications session, the query, and the insufficient allowable actions.

At block 808, the computer system 106 may receive, via the computer system associated with the second party, a response provided by the second party. The second party may use the computer system associated with the second party to select or modify one or more of the allowable actions determined by the programmatic agent. For example, the second party may instruct the programmatic agent to perform an allowable action that was not previously selected by the programmatic agent. In other examples, the second party may use the computer system associated with the second party to instruct the programmatic agent to perform a modified version of the one or more allowable actions. In further examples, the second party may determine, generate, or establish one or more custom allowable actions for the programmatic agent to perform.

At block 810, the computer system 106 may generate output data based on the received response. For example, the computer system 106 may instruct the programmatic agent to generate output data based on the received response. For example, the programmatic agent may generate textual output data that is sent to the first party via the device. In some examples, the communications session is a verbal communications session. The computer system or the programmatic agent may use various text-to-speech technologies to generate verbal output data. Text-to-speech technology, also known as text-to-voice, converts written text into spoken language. It is used in applications ranging from virtual assistants to transcription services. Example text-to-speech technologies include Google Cloud Text-to-Speech (which utilizes advanced models like “Chirp,” trained on millions of hours of audio and billions of text sentences); IBM Watson Text-to-Speech (which leverages deep learning and large language models to improve accuracy and handle informal speech patterns); Microsoft Azure Text-to-Speech; etc. In some examples, a natural language processing (NLP) text-to-speech technology is used. In other examples, text-to-speech functionality is implemented through the application of a trained machine learning or artificial intelligence process to the output data, for example, a neural network.

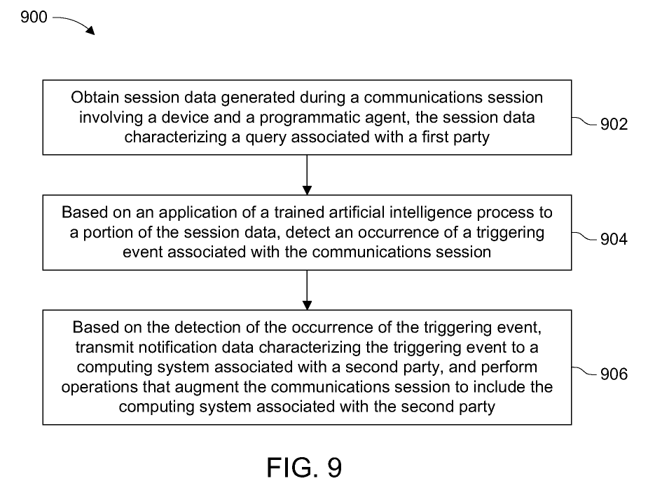

FIG. 9 is a flow diagram of an exemplary process 900 for detecting a triggering event in a communications session between a programmatic agent and a first party. In some instances, one or more computer systems operating within environment 100, such as the computer system 106, the device 102, or the device associated with the second party 112, may perform one or more of the blocks of exemplary computer-implemented method 900, which begins at block 902.

At block 902, the computer system 106 may obtain session data generated during a communications session involving a device and a programmatic agent, the session data characterizing a query associated with a first party. The session data may also characterize the communications session involving the device and the first party. The device may be the device 102 associated with the first party 102A, and the programmatic agent may be the programmatic agent 108, which may execute an LLM. The query may request information, assistance, or another action to be performed by the programmatic agent. The communications session may be a textual communications session, a verbal communications session, or another type of communications session implemented via a communications protocol. The session data characterizing the query associated with the first party may include information indicative of the query, metadata related to the communications session, or other information.

At block 904, the computer system 106 may, based on an application of a trained artificial intelligence or machine learning process to a portion of the session data, detect an occurrence of a triggering event associated with the communications session. The trained artificial intelligence or machine learning process may be an LLM. The computer system 106 may execute a monitoring agent which monitors the communications session and detects the occurrence of the triggering event based at least in part on the communications session and the session data.

Examples of triggering events include, but are not limited to: a misunderstood query, an inability of the programmatic agent 108 to generate a sufficient response to the query, a medical emergency, a presence of repetitive conversation flow within the communications session, or a presence of a flagged topic within the communications session. Other triggering events may be established, in some examples, based on an application of a trained machine learning or artificial intelligence process to the session data characterizing the communications session. For example, based on an application of a trained machine learning or artificial intelligence process to the session data characterizing the communications session, the computer system 106 may determine one or more events that may be designated as a triggering event for detection in future communications sessions.

The computer system 106 may detect triggering events in block 904 based on an application of a trained machine learning or artificial intelligence process to the session data characterizing the communications session. For example, an LLM may be used to analyze the session data characterizing the communications session. Based on the output of the LLM, the computer system 106 may detect a presence of a triggering event. In other examples, the computer system 106 may apply a trained machine learning or artificial intelligence to the session data characterizing the communications session, and based on the output of the trained machine learning or artificial intelligence process, the computer system 106 may determine a risk score or triggering event score. Based on the risk score or triggering event score, the computer system 106 may detect a presence of a triggering event.

At block 906, the computer system 106 may, based on the detection of the occurrence of the triggering event, transmit notification data characterizing the triggering event to a computer system associated with a second party, and perform operations that augment the communications session to include the computer system associated with the second party. The second party may be the second party 112. The notification data may include data characterizing the triggering event, details about the triggering event, and data associated with the conversation flow of the communications session involving the device and the programmatic agent. In some examples, the computer system associated with the second party may execute and display a GUI to be presented to the second party. The GUI includes the notification data and may display other data characterizing the communications session, the device, the first party, and the programmatic agent. In further examples, the GUI includes input/output functionality that allows the second party to select, modify, or determine actions for the programmatic agent to take in response to the detected triggering event.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The term "logic" may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein.

Computer executable components can be stored, for example, on non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device type, in accordance with the claimed subject matter.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Reference in the specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment.

It is contemplated that any number and type of components may be added to and/or removed to facilitate various embodiments including adding, removing, and/or enhancing certain features. For brevity, clarity, and ease of understanding, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

By way of illustration, both an application running on a server and the server can be a component. One or more components may reside within a process and/or thread of execution, and a component may be localized on one computer and/or distributed between two or more computers. Also, these components can execute from various non-transitory, computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

What is claimed is:

1. An apparatus, comprising:
a memory storing instructions; and
at least one processor coupled to the memory, the at least one processor being configured to execute the instructions to:
obtain session data generated during a communications session involving a device and a programmatic agent, the session data characterizing a query associated with a first party;
based on an application of a trained artificial intelligence process to a portion of the session data, generate output data characterizing one or more allowable actions and determine that at least one of the one or more allowable actions is consistent with one or more constraints imposed on the trained artificial intelligence process;
based on a determination that the at least one of the one or more allowable actions is insufficient to respond to the query, transmit notification data characterizing the at least one of the one or more allowable actions and the query to a computing system associated with a second party; and
receive response data characterizing a response to the query from the computing system associated with the second party.

2. The apparatus of claim 1, wherein:
the response to the query comprises an additional action; and
the response data characterizes the additional action, the computing system being configured to generate the output data based on the notification data.

3. The apparatus of claim 1, wherein:
the computing system is configured to select an additional one of the one or more allowable actions as the response to the query based on the notification data; and
the response data characterizes the selected additional one of the one or more allowable actions.

4. The apparatus of claim 1, wherein:
the computing system is configured to perform operations that determine, based on the notification data, a modification to the at least one of the one or more allowable actions, the modification to the at least one of the one or more allowable actions being sufficient to respond to the query; and
the response data characterizes the modification to the at least one of the one or more allowable actions.

5. The apparatus of claim 1, wherein the at least one processor is further configured to execute the instructions to process the response data and establish a second communications session involving the device and the computing system.

6. The apparatus of claim 1, wherein:
the response data comprises a training dataset; and
the at least one processor is further configured to perform operations that retrain the trained artificial intelligence process based on the training dataset.

7. The apparatus of claim 1, wherein the at least one processor is further configured to execute the instructions to:
perform operations that apply the trained artificial intelligence process to data characterizing a conversation graph associated with a predefined conversation flow of the communications session; and
determine that the at least one of the one or more allowable actions is insufficient to respond to the query based on the application of the trained artificial intelligence process to the conversation graph.

8. The apparatus of claim 1, wherein the communications session comprises a voice communications session involving the device and the programmatic agent.

9. The apparatus of claim 1, wherein the programmatic agent executes a large-language model (LLM) configured to accept the query as input.

10. The apparatus of claim 1, wherein the programmatic agent executes the trained artificial intelligence process.

11. A computer-implemented method comprising:
obtaining, using at least one processor, session data generated during a communications session involving a device and a programmatic agent, the session data characterizing a query associated with a first party;
based on an application of a trained artificial intelligence process to a portion of the session data, generating, using the at least one processor, output data characterizing one or more allowable actions and determining, by the at least one processor, that at least one of the one or more allowable actions is consistent with one or more constraints imposed on the trained artificial intelligence process;
based on a determination that the at least one of the one or more allowable actions is insufficient to respond to the query, transmitting, using the at least one processor, notification data characterizing the at least one of the one or more allowable actions and the query to a computing system associated with a second party; and
receiving, using the at least one processor, response data characterizing a response to the query from the computing system associated with the second party.

12. The computer-implemented method of claim 11, wherein:
the response to the query comprises at least one of an additional action or an additional one of the one or more allowable actions; and
the response data characterizes the at least one of the additional action or the additional one of the one or more allowable actions.

13. The computer-implemented method of claim 11, wherein:
the computing system is configured to perform operations that determine, based on the notification data, a modification to the at least one of the one or more allowable actions, the modification to the at least one of the one or more allowable actions being sufficient to respond to the query; and
the response data characterizes the modification to the at least one of the one or more allowable actions.

14. The computer-implemented method of claim 11, further comprising:
performing operations, using the at least one processor, that apply the trained artificial intelligence process to data characterizing a conversation graph associated with a predefined conversation flow of the communications session; and
determining, using the at least one processor, that the at least one of the one or more allowable actions is insufficient to respond to the query based on the application of the trained artificial intelligence process to the conversation graph.

15. An apparatus, comprising:
a memory storing instructions; and
at least one processor coupled to the memory, the at least one processor being configured to execute the instructions to:
obtain session data generated during a communications session involving a device and a programmatic agent, the session data characterizing a query associated with a first party;
based on an application of a trained artificial intelligence process to a portion of the session data, detect an occurrence of a triggering event associated with the communications session; and
based on the detection of the occurrence of the triggering event, transmit notification data characterizing the triggering event to a computing system associated with a second party, and perform operations that augment the communications session to include the computing system associated with the second party.

16. The apparatus of claim 15, wherein the triggering event comprises at least one of a misunderstood query, an inability of the programmatic agent to generate a sufficient response to the query, a presence of repetitive conversation flow within the communications session, or a presence of a flagged topic within the communications session.

17. The apparatus of claim 15, wherein:
the triggering event comprises a medical emergency; and
the at least one processor is further configured to detect the occurrence of the medical emergency based on an application of the trained artificial intelligence process to the portion of the session data.

18. The apparatus of claim 15, wherein the computing system associated with the second party is configured to generate additional session data characterizing a response to the occurrence of the triggering event and to provision the additional session data to the device during the augmented communications session.

19. The apparatus of claim 18, wherein:
the communications session and the augmented communications session comprise a voice communications session; and
the session data comprises an input audio signal and the additional session data comprises an output audio signal.

20. The apparatus of claim 15, wherein:
the at least one processor is further configured to execute the instructions to:
based on the application of a trained artificial intelligence process to the portion of the session data, generate output data characterizing one or more allowable actions and determine that at least one of the one or more allowable actions is consistent with one or more constraints imposed on the trained artificial intelligence process; and
determine that the at least one of the one or more allowable actions is insufficient to respond to the query; and
the occurrence of the triggering event corresponds to the determination that the at least one of the one or more allowable actions is insufficient to respond to the query.
